(19) United States
(12) Patent Application Publication
(10) Pub. No.: US 2026/0367336 A1
(43) Pub. Date: Nov. 19, 2026

(54) OPTICAL CONNECTOR ATTACHMENT/DETACHMENT JIG AND ATTACHMENT/DETACHMENT METHOD

(71) Applicants: HAKUSAN INC., Ishikawa (JP); NTT, Inc., Tokyo (JP)

(72) Inventors: Kentaro MATSUDA, Ishikawa (JP); Motohito TAKEZAKI, Ishikawa (JP); Kota SHIKAMA, Tokyo (JP); Yoshiyuki DOI, Tokyo (JP); Yuzo ISHII, Tokyo (JP)

(21) Appl. No.: 19/126,539

(22) PCT Filed: Nov. 8, 2023
(86) PCT No.: PCT/JP2023/040172

§ 371 Date: May 1, 2025

(30) Foreign Application Priority Data
Nov. 9, 2022 (JP) 2022-179906

(51) Int. Cl. G02B 6/38

(52) U.S. Cl. CPC G02B 6/3898; G02B 6/3886

(57) ABSTRACT

[Problem] To provide an optical connector attachment/detachment jig and an attachment/detachment method, whereby attachment/detachment can be facilitated in attachment/detachment of an optical connector in which a receptacle comprising a magnetic body and a plug comprising a magnet are connected by magnetic force.

[Solution] An optical connector attachment/detachment jig 90 for attaching/detaching an optical connector in which a receptacle including a magnetic body and a plug including a magnet are coupled by magnetic force, the optical connector attachment/detachment jig 90 comprising: a front part 10 that is formed from a magnetic body and covers a periphery of the magnet 230; and a plug engagement part 30 that engages with a distal-end part in a connection direction of the plug 200 to remove the plug 200 from the receptacle 100, wherein the plug engagement part 30 is a constricted portion that is formed on a side of the receptacle 100 of the front part 10 and has an inside diameter smaller than an outside diameter of an end part of the plug 200.

### TECHNICAL FIELD

The present invention relates to a jig for attaching/detaching an optical connector that optically connects optical waveguide components to each other by magnetic force and to an attachment/detachment method.

### BACKGROUND ART

Various methods other than conventional standardized methods such as MPO have been proposed as methods for connecting optical waveguide components such as optical fibers.

For example, Patent Literature 1 (International Publication No. WO 2021/111773) discloses a compact optical connection component that uses magnets to hold and press optical waveguide components together.

The optical connection component described in Patent Literature 1 is an optical connection component that connects to another optical connection component, the optical connection component including: an optical waveguide component; an alignment component that fixes the optical waveguide component; and a magnetic structure to be integrated with the alignment component, wherein a connecting end surface of the alignment component is provided with an alignment structure that determines relative positions of the connecting end surface and a connecting end surface of an alignment component included in the other optical connection component.

As an embodiment of Patent Literature 1, a mode including a pair of coupling components made up of divided parts is disclosed. The divided parts oppose each other by two surfaces, with one surface magnetized to an N pole and the other surface magnetized to an S pole, and are magnetized in an outer circumferential direction of the optical fiber alignment component.

Patent Literature 2 (Japanese Patent Laid-Open No. 2004-029633) discloses an optical fiber connector with little variability in coupling loss and high reliability, which enables connection work and removal work to be readily performed, and the like.

The optical fiber connector described in Patent Literature 2 is an optical fiber connector including a magnetic body having a hole through which an optical fiber is inserted and fixed, and is provided with means to reduce a coefficient of friction of a connecting surface of the magnetic body with a counterpart optical fiber connector. A configuration is adopted in which means for mitigating an impact that occurs when connecting with the counterpart optical fiber connector is provided on a connecting surface side of the magnetic body with the counterpart optical fiber connector and when not connected to the counterpart optical fiber connector, an end surface of the optical fiber is positioned inside with respect to a connecting surface of the magnetic body, but when connected to the counterpart optical fiber connector, the end surface of the optical fiber comes into contact with an end surface of an optical fiber of the counterpart.

Patent Literature 3 (International Publication No. WO 2022/074866) discloses an optical connector that can suppress ferrule wear when attaching and detaching optical connectors and that optically connects optical communications using magnets.

The optical connector described in Patent Literature 3 includes a body part that has a fiber hole into which a first optical fiber can be inserted and a connection end surface on which the fiber hole opens, contains therein a material that generates magnetic force, and is configured to optically connect the first optical fiber to a second optical fiber using the magnetic force.

Patent Literature 3 discloses, as an embodiment, a body part that has: a guide pin guide hole extending along an axial direction of the fiber hole and opening on the connection end surface; and an accommodating part in which a permanent magnet is accommodated.

Patent Literature 4 (International Publication No. WO 2014/010035) discloses an optical connector for coupling signals in a highly efficient manner between optical transmission mediums such as a large number of optical fibers and a large number of optical waveguides in a multi-channel optical interconnect that uses optical signals to transmit and receive high capacity signals between substrates having electronic circuits such as integrated circuits incorporated therein, and an optical connector connection method that achieves connection and disconnection of the optical connector using a simple method.

The optical connector described in Patent Literature 4 is an optical connector made up of a first connector member and a second connector member, wherein the first connector member includes a rear part, an optical fiber through-hole passing through the rear part, a fixing part for fixing an optical fiber provided in the rear part, and a first alignment part provided on a rear part surface, the second connector member includes a rear part, an optical fiber through-hole passing through the rear part, a fixing part for fixing an optical fiber provided in the rear part, and a second alignment part provided on a rear part surface, a magnet is provided in a portion that connects to the second alignment part on a surface of the first alignment part, a magnetic body is provided in a portion that connects to the magnet on a surface of the second alignment part, the magnet of the first connector member connects with the magnetic body of the second connector member to connect the connector members so as to optically connect the optical fiber fixed to the first connector member and the optical fiber fixed to the second connector member to each other, and the first alignment part further includes magnetic force shielding means.

### CITATION LIST

### Patent Literature

Patent Literature 1: International Publication No. WO 2021/111773
Patent Literature 2: Japanese Patent Laid-Open No. 2004-029633
Patent Literature 3: International Publication No. WO 2022/074866
Patent Literature 4: International Publication No. WO 2014/010035

### SUMMARY OF INVENTION

### Technical Problem

The optical connectors described in Patent Literatures 1 to 4 above all use magnetic force to bring optical waveguide components into contact with each other. In this case, a strong pressing force is required to bring, particularly, multichannel optical waveguide components into contact with each other while satisfying specified connection loss and, in order to do so, magnetic force must be increased. However, there has been a problem that it is very difficult to remove optical waveguide components from each other while the optical waveguide components are being subjected to a strong magnetic force without destroying the optical waveguide components, magnets, or peripheral components and it is also very difficult to mount the optical waveguide components to each other while the optical waveguide components are being subjected to a strong magnetic force while maintaining positional accuracy of each of the optical waveguide components.

In particular, when optical connection terminals are provided on electronic substrates of servers or the like to perform high-speed, large-capacity information communication between the servers or between the substrates using optical communication, it is difficult to secure space around the optical connection terminals for inserting an attaching/detaching tool and other tools, and thus the aforementioned difficulties are further increased.

Although alignment by guide pins is described in Patent Literature 1, there is no specific description of how to remove optical waveguide components from each other when they are subjected to a strong magnetic force.

Patent Literature 2 describes an optical fiber connector in which a cushioning material is arranged in order to mitigate impact that is generated during connection. However, there is no specific description of how to remove optical waveguide components from each other when they are subjected to a strong magnetic force. In addition, arranging the cushioning material between two magnetic bodies makes it impossible to control positions of the magnetic bodies with precision and makes it difficult to control connection loss of the optical connector.

Furthermore, Patent Literature 3 describes an example of arranging a permanent magnet in a guide hole of an MT ferrule. However, while a contact force of several N to a dozen N is required for high-density, large-capacity optical communication using a multi-fiber MT ferrule, it is difficult to apply such a large force to a connection end surface by a permanent magnet arranged in a guide hole.

Moreover, in Patent Literature 4, a mechanism is provided in which a magnet of an alignment part rotates in order to simplify disconnection of optical connectors. However, it is difficult to precisely control the position of magnet terminals that serve as alignment marks in order to achieve optical connectors with low loss and little variability in connection loss, particularly in the case of multi-channel optical connectors.

A main object of the present invention is to provide, in attachment/detachment of a multi-channel optical connector in which a receptacle and a plug including a magnet are coupled by magnetic force and a pressing force is applied particularly during connection, an optical connector attachment/detachment jig and an attachment/detachment method, whereby attachment/detachment can be facilitated, positional accuracy during mounting can be secured, and damage to the optical connector during attachment/detachment can be suppressed.

### Solution to Problem

(1)

An optical connector attachment/detachment jig according to first aspect is an optical connector attachment/detachment jig for attaching/detaching an optical connector in which a receptacle including a magnetic body and a plug including a magnet are coupled by magnetic force, the optical connector attachment/detachment jig including: a front part that is formed from a magnetic body and covers a periphery of the magnet; and a plug engagement part that engages with a distal-end part in a connection direction of the plug to facilitate removal of the plug from the receptacle, wherein the plug engagement part is a constricted portion that is formed on a side of the receptacle of the front part and has an inside diameter smaller than an outside diameter of an end part of the plug.

With multi-channel MPO connectors, a pressing force of 10 N to 20 N must be applied between ferrules in order to realize an optical connector with low loss and little variability in connection loss. Therefore, an optical connector to be coupled by magnetic force may also require an equivalent pressing force.

However, when an equivalent pressing force is formed by magnetic force, simply moving the plug closer to the receptacle when mounting the optical connector will make it difficult to control positions of the plug and the receptacle due to the strong pressing force. In addition, since the magnetic force of a magnet increases as the distance gets shorter, there is also a problem in that ferrules of the plug and the receptacle collide strongly with each other in an accelerated manner, resulting in damage.

On the other hand, when removing the optical connector, there are problems such as the removal being made difficult by the strong pressing force and forcibly removing the optical connector may result in damaging the optical connector.

The optical connector attachment/detachment jig according to the first aspect is capable of improving controllability during mounting and removal of an optical connector and preventing damage to the optical connector by covering a periphery of the magnet with the front part formed from a magnetic body during mounting and removal of the optical connector and bringing the front part close to the magnet, thereby causing magnetism from the magnet to leak to the attachment/detachment jig via the front part that is a magnetic body, thereby reducing magnetic force between the receptacle and the plug including the magnet to reduce a pressing force between the plug and the receptacle. Note that after mounting of the optical connect is completed, the pressing force between the plug and the receptacle is restored to its original value by removing the attachment/detachment jig from the plug.

In addition, control of a distance between the plug and the receptacle is important to improve controllability during mounting and removal of the optical connector. In the optical connector attachment/detachment jig according to the first aspect, since providing a plug engagement part that engages with the receptacle-side end part of the plug in the connection direction enables the distance between the plug and the receptacle to be controlled, connection and removal of the plug and the receptacle can be facilitated, and unnecessary collisions or the like can be prevented when in close proximity to inflict damage.

Note that the term magnetic body as used herein includes hard magnetic materials and/or soft magnetic materials.

The optical connector may be provided with a magnet on the receptacle side and a magnetic body on the plug side or provided with magnets on both the receptacle side and the plug side. In addition, the distal-end part in the connection direction of the plug need not be a leading end portion (a portion furthest toward the receptacle side) in the entire plug and may be a corner on a side of the connection direction of a magnet as in the example. Furthermore, besides a constricted portion, the plug engagement part may be configured to allow engagement of the front part of the optical connector attachment/detachment jig with the plug of the optical connector such as a protrusion and a notch.

Note that, in the present aspect, the respective descriptions of a “jig for attachment/detachment”, a “jig that engages with the plug”, and the like mean a “jig configured to enable attachment/detachment”, a “jig configured to be capable of engaging with the plug”, and the like and are not intended to limit jigs to those in a state of engagement with the plug.
(2)

An optical connector attachment/detachment jig according to second aspect is the optical connector attachment/detachment jig according to the first aspect, wherein the plug may have a connection plate of a soft magnetic body on a side of the receptacle of the magnet, the magnet may include a first magnet and a second magnet having an N pole and an S pole along a longitudinal direction of an optical waveguide component and being configured to face each other and to encompass the optical waveguide component, and the front part may be formed from a soft magnetic body and may cover the first magnet and the second magnet to cause a magnetic circuit constituted of the first magnet and the second magnet to leak to a side of the front part to reduce the magnetic force between the receptacle and the plug.

In an optical connector coupled by magnetic force, the receptacle-side end parts of the first magnet and the second magnet constitute an N pole and an S pole, respectively, and a magnetic circuit is constructed from the N pole to the S pole through the magnetic body of the receptacle, thereby generating a strong magnetic force between the receptacle and the plug.

In the optical connector attachment/detachment jig according to the second aspect, the N pole and the S pole of the magnets can be covered by the connection plate that is a soft magnetic body and the front part that is also a soft magnetic body. Accordingly, the magnetic circuit constituted of the first magnet and the second magnet is leaked to the side of the front part to reduce the magnetic force between the receptacle and the plug.
(3)

An optical connector attachment/detachment jig according to third aspect is the optical connector attachment/detachment jig according to the first or second aspect, further including a rear part, wherein the rear part may be connected to the front part by a screw and may engage with an upper surface and/or side surfaces of a yoke arranged on a rear-end part side of the magnet, and the plug engagement part may engage with a distal-end part of the magnet.

Note that the distal-end part of the magnet refers to the side of the receptacle in the connection direction of the plug and the rear-end part of the magnet refers to an end part on an opposite side to the connection direction in the magnet. Therefore, the yoke is arranged on an opposite side to the receptacle side of the magnet.

Since the front part engages with the end part on the connection plate side of the magnet, magnetism that was flowing into the receptacle via the connection plate can be effectively released to the front part side to cause leakage of the magnetic circuit.

In addition, since connecting the present optical connector attachment/detachment jig to the optical connector causes the magnet of the optical connector to be encompassed by the connection plate, the optical connector attachment/detachment jig (front part and rear part), and the yoke, the magnetic circuit can be caused to leak to the front part in an effective manner.

In addition, rare earth magnets that are capable of generating strong magnetic force even though they are small have the problem that they are particularly susceptible to cracking and produce a large amount of sintering shrinkage. Therefore, when controlling the position of the plug by the engagement of the magnet and the front part, positional accuracy within a plane perpendicular to the connection direction of the plug may possibly be insufficient.

In contrast, the optical connector attachment/detachment jig according to the third aspect further includes a rear part and is capable of improving positional accuracy by, for example, causing an upper surface and both side surfaces of a yoke formed from a soft magnetic metal such as SUS with high processing precision and the rear part to engage with each other.

Furthermore, since the plug of the optical connector is very small and the optical connector attachment/detachment jig and the plug attract each other strongly, it may be difficult to remove the optical connector attachment/detachment jig from the plug.

Since the optical connector attachment/detachment jig according to the third aspect enables the rear part and the front part to be separated, the optical connector attachment/detachment jig and the plug can be readily separated from each other.

Note that the optical connector attachment/detachment jig and the connection plate are preferably soft magnetic bodies. In addition, further preferably, the yoke is also a soft magnetic body. Accordingly, the magnet of the plug is to be covered by soft magnetic bodies by mounting the optical connector attachment/detachment jig to the plug. Therefore, since an effect of the attraction of the magnet on the plug can be reduced, the separation of the plug and the receptacle can be further facilitated.
(4)

An optical connector attachment/detachment jig according to fourth aspect is the optical connector attachment/detachment jig according to any one of the first to third aspects, wherein each of the first magnet and the second magnet of the plug may have a left-right symmetrical U-shape with an upper surface and a lower surface of each magnet configured to be flush with each other, and the front part may be in contact with the upper surface of each magnet.

When the first magnet and the second magnet that encompass the optical waveguide component are flush with each other on the upper surface and the lower surface of the plug, bringing the front part formed from a magnetic body into contact with the upper surface of the plug where the first magnet and the second magnet are adjacent to each other enables a larger amount of the magnetic circuit constituted by the first magnet and the second magnet to leak to the front part side.

In addition, the magnet may be configured so that not only the upper surface but also the lower surface can be in contact with the magnetic body.
(5)

An optical connector attachment/detachment jig according to fifth aspect is the optical connector attachment/detachment jig according to any one of the first to fourth aspects, wherein the front part may include a guide mechanism that protrudes toward the receptacle side and engages with the upper surface and/or the side surfaces of the receptacle.

When inserting the plug into the receptacle, it is important to align a guide pin on the receptacle side with a guide hole on the plug side. In the optical connector attachment/detachment jig according to the fifth aspect, the front part of the optical connector attachment/detachment jig includes the guide mechanism that protrudes toward the receptacle side, and the alignment described above is precisely performed by, for example, having the guide mechanism engage with the upper surface and side surfaces of the receptacle or with any two surfaces among the upper surface and both side surfaces.
(6)

An attachment/detachment method of an optical connector according to sixth aspect is an attachment/detachment method of an optical connector in which a receptacle including a magnetic body and a plug including a magnet are coupled by magnetic force, wherein when attaching/detaching the optical connector, a periphery of the magnet is covered by an optical connector attachment/detachment jig formed from a magnetic body to cause a magnetic circuit constituted of the magnet to leak to the optical connector attachment/detachment jig and reduce a magnetic force between the receptacle and the plug.

The attachment/detachment method of an optical connector according to the sixth aspect is aspect of an attachment/detachment method of an optical connector that corresponds to the optical connector attachment/detachment jig according to any one of the aspects of the first aspect to the fifth aspect.

In the attachment/detachment method of an optical connector according to the sixth aspect, when attaching/detaching a multi-channel optical connector, attachment/detachment can be facilitated, positional accuracy during mounting can be secured, and suppression of damage to the optical connector during attachment/detachment can be achieved, by reducing the magnetic force between a receptacle and a plug.

### BRIEF DESCRIPTION OF DRAWINGS

FIG. 1 is a schematic perspective view showing a state where an optical connector attachment/detachment jig according to the present embodiment is engaged with an optical connector.

FIG. 2 is a schematic perspective view of the optical connector attachment/detachment jig according to the present embodiment.

FIG. 3(a) is a schematic perspective view of a rear part of an attachment/detachment jig and FIG. 3(b) is a schematic perspective view of a front part.

FIG. 4(a) is a schematic front view of the rear part, FIG. 4(b) is a schematic bottom view of the rear part, and FIG. 4(c) is a schematic side view of the rear part.

FIG. 5(a) is a schematic front view of the front part, FIG. 5(b) is a schematic bottom view of the front part, and FIG. 5(c) is a schematic side view of the front part.

FIG. 6 is a schematic perspective view showing a receptacle and a plug of the optical connector in a coupled state.

FIG. 7 is a schematic perspective view showing the receptacle and the plug of the optical connector in a separated state.

FIG. 8 is a schematic perspective view of a state where the optical connector attachment/detachment jig is engaged with the plug as viewed from a lower surface side of the optical connector.

FIG. 9 is a schematic view showing a state before engagement of the attachment/detachment jig in case mounting the optical connector.

FIG. 10 is a schematic view showing a state during engagement of the attachment/detachment jig in case mounting the optical connector.

FIG. 11 is a schematic view showing a state during removal of the plug in case mounting the optical connector.

FIG. 12 is a schematic view showing a state during removal of the attachment/detachment jig in case mounting the optical connector.

### DESCRIPTION OF EMBODIMENT

Hereinafter, an embodiment of the present invention will be described with reference to the drawings.

In the following description, same components are assigned the same reference signs. In addition, names and functions of such components are also the same. Therefore, detailed descriptions of such components will not be repeated.

### Present Embodiment

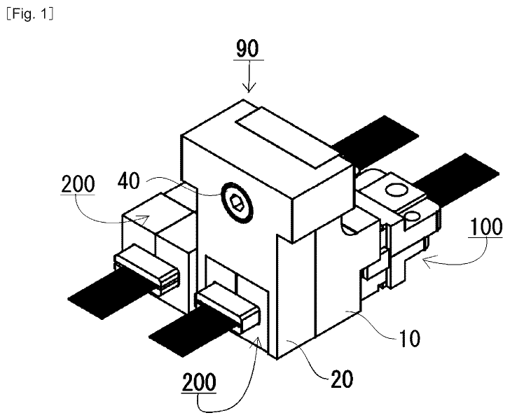

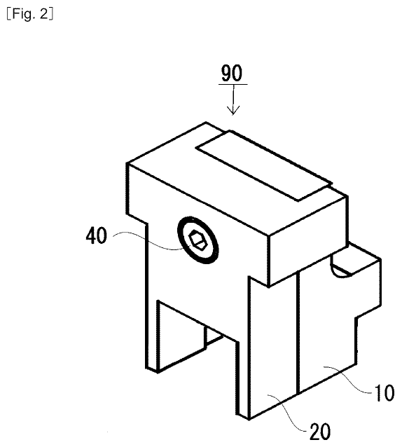

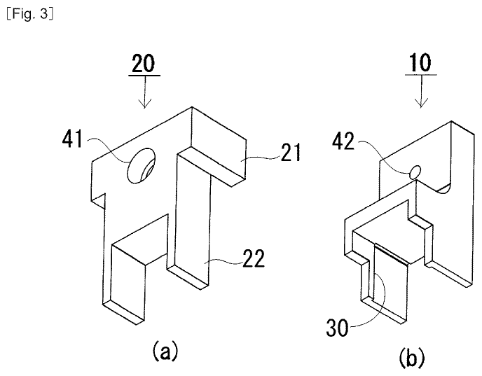

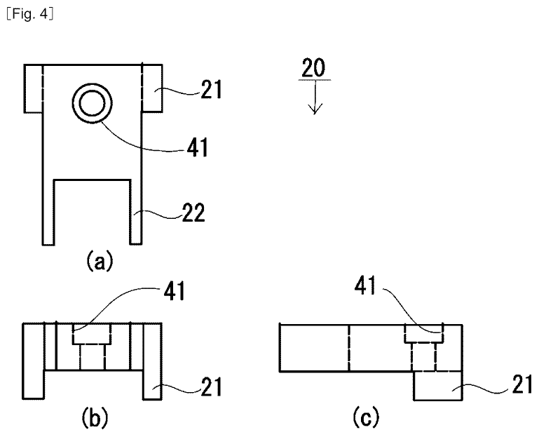

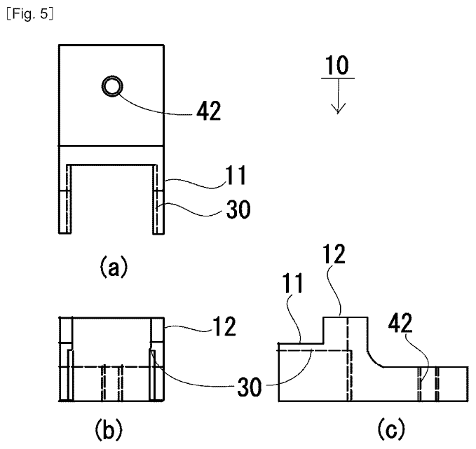

FIG. 1 is a schematic perspective view showing a state where an optical connector attachment/detachment jig 90 according to the present embodiment is engaged with an optical connector 300, and FIG. 2 is a schematic perspective view of the optical connector attachment/detachment jig 90. In addition, FIG. 3(a) is a schematic perspective view of a rear part 20 in a state where the optical connector attachment/detachment jig 90 has been disassembled, and FIG. 3(b) is a schematic perspective view of a front part 10. FIGS. 4(a), 4(b), and 4(c) are a front view, a sectional view as viewed from a lower surface, and a sectional view as viewed from a side surface of the rear part 20, respectively, and FIGS. 5(a), 5(b), and 5(c) are a front view, a sectional view as viewed from a lower surface, and a sectional view as viewed from a side surface of the front part 10, respectively.

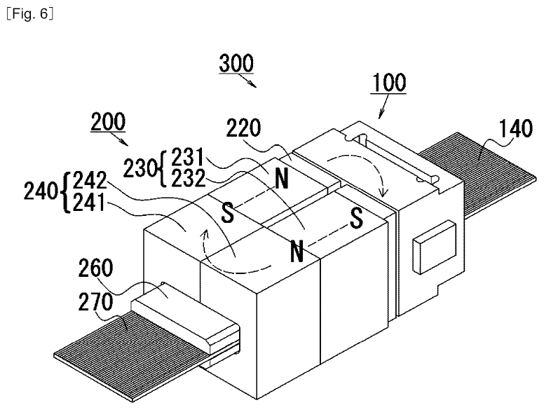

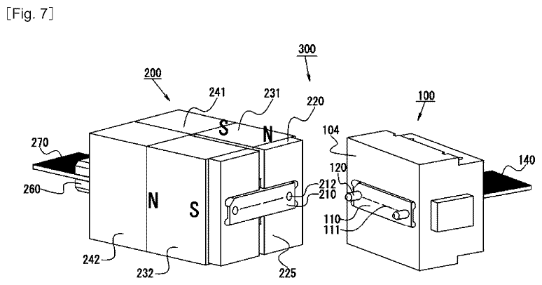

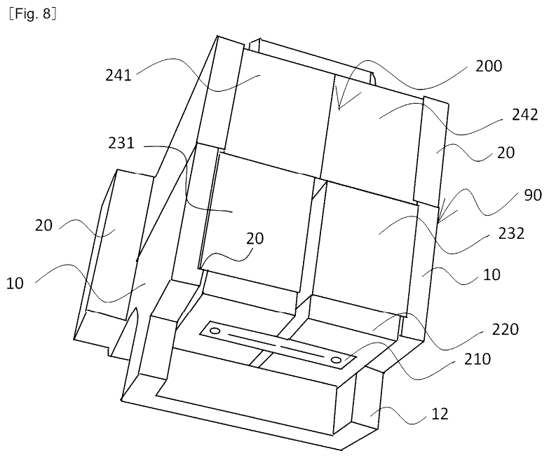

In addition, FIG. 6 is a schematic perspective view showing a receptacle 100 and a plug 200 in a coupled state, and FIG. 7 is a schematic perspective view showing the receptacle 100 and the plug 200 in a separated state. Furthermore, FIG. 8 is a schematic perspective view of a state where the optical connector attachment/detachment jig 90 is engaged with the plug 200 as viewed from a lower surface side of the optical connector 300.

In the optical connector 300 that is a main object of attachment/detachment of the optical connector attachment/detachment jig 90 according to the present embodiment, the receptacle 100 and the plug 200 are strongly coupled to each other by magnetic force and it is difficult to remove the plug 200 from the receptacle 100 as it is.

By covering a periphery of a magnet 230 (refer to FIG. 6) of the plug 200 with the front part 10 formed from a magnetic body and causing magnetism from the magnet to leak to the optical connector attachment/detachment jig via the front part that is a magnetic body, the optical connector attachment/detachment jig 90 can reduce a magnetic force between the receptacle 100 and the plug 200. Therefore, since a pressing force between the receptacle 100 and the plug 200 can be reduced, an improvement in controllability and prevention of damage to the optical connector 300 during mounting and removal of the optical connector 300 can be achieved.

While the magnet 230 is provided in the plug 200 in the present embodiment, the magnet 230 may be provided in the receptacle 100 or the magnet 230 may be provided in both the plug 200 and the receptacle 100.

### structure of Optical Connector Attachment/Detachment Jig 90

As shown in FIG. 2, the optical connector attachment/detachment jig 90 is constructed by connecting the rear part 20 and the front part 10 to each other by a screw 40 such as a bolt. Among these components, the front part 10 is formed from a magnetic body and, from the perspectives of machining accuracy, physical strength, and the like, the front part 10 is desirably formed from a soft magnetic body such as SUS 430 or SUS 630. The rear part 20 may also be formed from a soft magnetic body such as SUS 430 or SUS 630.

In the front part 10, thickness on a side of the receptacle 100 of a leg part 11 that comes into contact with the plug 200 is increased to form a constricted portion and, accordingly, the constricted portion engages with a distal-end part of the plug 200 on the side of the receptacle 100 in a connection direction of the magnet 230 and functions as a plug engagement part 30. In other words, when removing the plug 200 from the receptacle 100, by causing the plug engagement part 30 to engage with the distal-end part on the side of the receptacle 100 of the magnet 230 and pulling out the plug 200 from the receptacle 100 in a state where the magnet 230 is covered by the front part 10 and a magnetic force between the plug 200 and the receptacle 100 is reduced, the plug 200 can be removed without damaging the optical connector 300.

Note that the plug engagement part 30 is not limited to a structure in which a constricted portion is formed in the front part 10 described above. For example, a structure that enables the front part 10 and the magnet 230 to engage with each other can be adopted by, for example, forming a protrusion in the front part 10 and forming a notch in the magnet 230.

In addition, the front part 10 is provided with a screw hole 42 in an upper part thereof and is fixed to the rear part 20 by the screw 40.

The rear part 20 is fitted to the front part 10 with the screw 40 via a hole 41 and firmly fixes the front part 10 with a wing part 21 that protrudes from the upper part toward a side of the front part 10.

In addition, a leg part 22 of the rear part 20 can be formed from a soft magnetic body such as SUS 430, and by causing the leg part 22 to engage with both side surfaces of a yoke 240 formed from a soft magnetic body with higher machining accuracy than the magnet 230, position control accuracy of the plug 200 can be improved.

### Structure of Optical Connector 300

FIG. 6 shows a structure of the receptacle 100 and the plug 200 of the optical connector 300 in a coupled state, and FIG. 7 shows a structure of the receptacle 100 and the plug 200 of the optical connector 300 in a separated state.

In the optical connector 300 to be an object of attachment/detachment of the optical connector attachment/detachment jig 90 according to the present embodiment, the magnet 230 is provided in the plug 200 and attraction acts between the receptacle 100 and the plug 200 due to magnetic force of the magnet 230. Accordingly, a pressing force is applied to a connecting surface 104 between the receptacle 100 and the plug 200 and an optical fiber 140 and an optical fiber 270 can be connected to each other.

As shown in FIGS. 6 and 7, the optical connector 300 is configured so that the receptacle 100 and the plug 200 can be connected to each other. The receptacle 100 includes a plate-like ferrule 110 to which the optical fiber 140 is connected on a side of the connecting surface 104 and includes a guide pin 120 that determines a connection position of the plate-like ferrule 110 and a plate-like ferrule 210.

The plug 200 includes the plate-like ferrule 210 to which the optical fiber 270 is connected on a connecting surface 225 and also includes a connection plate 220 having a depressed part, the magnet 230 arranged adjacent to a rear surface of the connection plate 220 (a surface opposite to the connecting surface 225), and the yoke 240 arranged at a rear-end part of the magnet 230 in the connection direction of the plug (an opposite side to the side of the connection plate 220). In addition, the plug 200 includes a boot 260 that holds, in parallel, an optical waveguide component extending from the plate-like ferrule 210.

The magnet 230 is made up of a first magnet 231 and a second magnet 232 and, in the plug 200, the first magnet 231 and the second magnet 232 each have a left-right symmetrical U-shape, have an upper surface and a lower surface that are flush with each other, respectively, and are arranged so that their polarities are opposite. The first magnet 231 and the second magnet 232 are formed from a rare earth magnet such as a neodymium magnet. In addition, the connection plate 220, the receptacle 100, and the yoke 240 are formed from a soft magnetic body such as SUS 430 or SUS 630.

Therefore, as illustrated in FIG. 6, a magnetic force generated from an N pole of the first magnet 231 reaches the receptacle 100 via the connection plate 220. In addition, the magnetic force reaches an S pole of the second magnet 232 from the receptacle 100 via the connection plate 220. Furthermore, a magnetic force generated from an N pole of the second magnet 232 reaches an S pole of the first magnet 231 via the yoke 240.

In other words, since a closed magnetic circuit is to be formed when the plug 200 is connected to the receptacle 100, the receptacle 100 and the plug 200 are strongly attracted to each other and a strong contact force can be applied to connecting end surfaces. As a result, the optical connector 300 with a small size and low loss can be realized.

The receptacle 100 has a depressed part into which the plate-like ferrule 110 can fit on the connecting surface 104 and also has a hole therein into which the optical fiber 140 can be inserted (not illustrated). In addition, since the receptacle 100 according to the present embodiment is formed from a soft magnetic material, attraction that attracts the receptacle 100 and the magnet 230 to each other acts and, accordingly, a pressing force can be obtained between the receptacle 100 and the plug 200.

In the receptacle 100, two guide pins 120 protrude from the connecting surface 104 and, accordingly, the plate-like ferrule 110 of the receptacle 100 and the plate-like ferrule 210 of the plug 200 are precisely aligned and optically connected to each other.

### Engagement State of Plug 200 and Optical Connector Attachment/Detachment Jig 90

FIG. 8 is a schematic perspective view of a state where the optical connector attachment/detachment jig 90 is engaged with the plug 200 as viewed from a lower surface side of the optical connector 300. The front part 10 covers the upper surface and the side surfaces of the magnet 230 (231 and 232) and the rear part 20 covers the upper surface and the side surfaces of the yoke 240 (241 and 242) arranged on a far side of the magnet 230 (231 and 232) from the receptacle 100.

In addition, by covering the upper surface and the side surfaces of the magnet 230 (231 and 232) with the front part 10, a magnetic circuit, in which a magnetic force generated from the N pole of the first magnet 231 reaches the receptacle 100 via the connection plate 220 and further reaches the S pole of the second magnet 232 from the receptacle 100 via the connection plate 220, can be caused to leak to the front part 10 and the magnetic force between the receptacle 100 and the plug 200 can be reduced.

The front part 10 shown in FIG. 8 is provided with a guide mechanism 12 that protrudes toward the side of the receptacle 100, and when inserting the plug 200 into the receptacle 100, the guide mechanism 12 engages with the upper surface and both side surfaces of the receptacle 100 or with any two surfaces among the upper surface and both side surfaces.

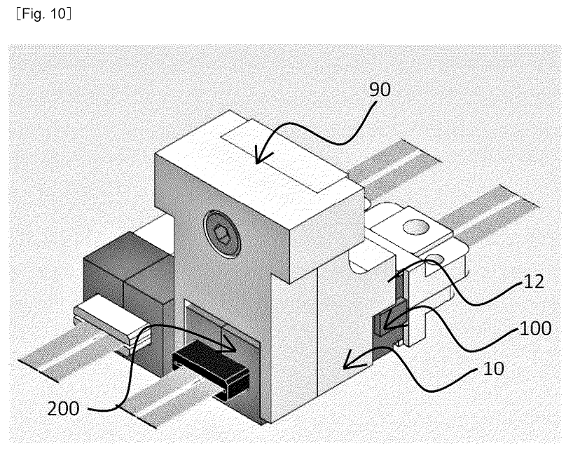

Accordingly, alignment can be achieved before the guide pin 120 on the side of the receptacle 100 enters a guide hole 212 on the side of the plug and high-precision insertion and removal of a connector can be readily performed (refer to FIGS. 8 and 10).

Since holding the plug 200 with the optical connector attachment/detachment jig 90 enables a magnetic force with respect to the receptacle 100 to be reduced, the plug 200 and the receptacle 100 can be connected while aligning the two. Therefore, the guide pin 120 of the receptacle 100 can be securely inserted into the guide hole 212 of the plug 200 and precise alignment can be performed in a safe and accurate manner. In particular, although magnetic force can become extremely strong when the plug 200 and receptacle 100 are in close proximity, since the optical connector attachment/detachment jig 90 reduces the magnetic force, problems such as the guide pin 120 colliding against the connection end surface can be prevented in an effective manner.

In addition, the plug engagement part 30 of the front part 10 engages with an end part on the side of the receptacle 100 of the magnet 230 (231 and 232), and by retracting the optical connector attachment/detachment jig 90 from the receptacle 100, the guide pin 120 can be safely pulled out of the plate-like ferrule 210. Therefore, the plug 200 can be removed without damaging the optical connector 300.

Note that the rear part 20 is formed from a soft magnetic body such as SUS 430 with high machining accuracy, and by causing the rear part 20 to engage with the yoke 240 (241 and 242) with higher machining accuracy than the magnet 230, position control accuracy of the plug 200 is improved.

### Flow During Removal of Plug 200 by Optical Connector Attachment/Detachment Jig 90

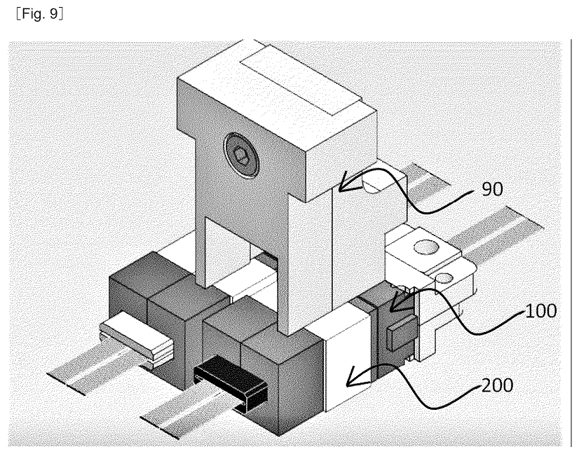

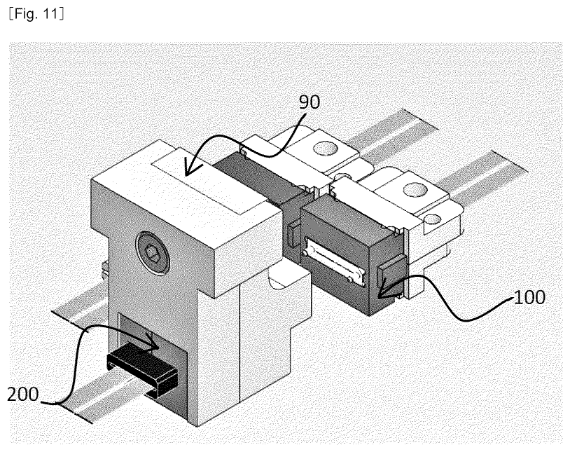

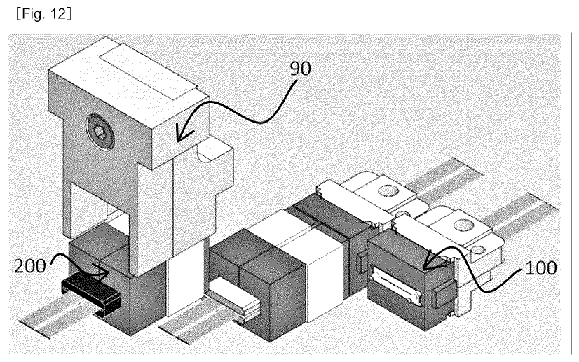

FIGS. 9 to 12 show a flow when removing the plug 200 from the receptacle 100 using the optical connector attachment/detachment jig 90.
FIG. 9: Arrange the optical connector attachment/detachment jig 90 in an upper part of the plug 200 coupled to the receptacle 100. In this case, it is important to perform alignment so that the rear part 20 of the optical connector attachment/detachment jig 90 and the yoke 240 can engage with each other and, at the same time, the front part 10 and the magnet 230 can engage with each other.
FIG. 10: Slowly lower the optical connector attachment/detachment jig 90 and cause the rear part 20 of the optical connector attachment/detachment jig 90 and the yoke 240 to engage with each other and the front part 10 and the magnet 230 to engage with each other.
FIG. 11: In a state where the plug engagement part 30 of the front part 10 is engaged with the magnet 230 (231 and 232) (refer to FIG. 8), move the optical connector attachment/detachment jig 90 in a direction of separation from the receptacle 100 to remove the plug 200 from the receptacle 100.
FIG. 12: In a state where the plug 200 is fixed (not illustrated), slowly raise the optical connector attachment/detachment jig 90 to separate the optical connector attachment/detachment jig 90 and the plug 200 from each other.

In this case, separating the rear part 20 and the front part 10 of the optical connector attachment/detachment jig 90 from each other by first removing the screw 40 connecting the rear part 20 and the front part 10 facilitates separation of the optical connector attachment/detachment jig 90 and the plug 200.

While this concludes the description of the flow when removing the plug 200 from the receptacle 100, the operations need only be performed in reverse in the order of FIG. 12, FIG. 11, FIG. 10, and FIG. 9 when mounting the plug 200 to the receptacle 100.

Note that when inserting the plug 200 into the receptacle 100, it is important to align the guide pin 120 on the side of the receptacle 100 with the guide hole 212 on the side of the plug. In the present invention, the alignment described above is precisely performed by having the guide mechanism 12 that protrudes toward the side of the receptacle 100 of the front part 10 of the optical connector attachment/detachment jig 90 engage with the upper surface and both side surfaces of the receptacle 100 or with any two surfaces among the upper surface and both side surfaces (refer to FIG. 10).

### Examples

The front part 10 and the rear part 20 of the optical connector attachment/detachment jig 90 according to the present example were both formed from SUS 430, both with a height of 19 mm, a width of 10 mm, and a width including the wing part 21 of 14 mm.

A depth of the rear part 20 in the connection direction of the optical connector 300 was 5 mm, and the wing part 21 further protruded in a direction of the front part 10 by 3 mm. A width between the leg parts 22 was 8.1 mm and a thickness of the leg parts 22 themselves was 1 mm.

In addition, a depth of the front part 10 in the connection direction was 8.5 mm including the guide mechanism 12 that protrudes toward the side of the receptacle 100 and, in the depth of the front part 10 in the connection direction, a depth of the leg part 11 was 5 mm. A width between the leg parts 11 was 8.7 mm in a portion where the magnet 230 is to be accommodated and 8.1 mm in the plug engagement part 30, and a thickness of the leg parts 11 themselves was 1 mm. Accordingly, the plug engagement part 30 was formed so as to be constricted inward by 0.3 mm on both left and right sides. Note that the shape of the optical connector attachment/detachment jig 90 according to the present example is designed so that the optical connector attachment/detachment jig 90 can be used even when there are two sets of the optical connectors 300 and the distance between the optical connectors 300 is short. When the optical connector 300 is arranged independently and there are no peripheral obstacles, the shape of the optical connector attachment/detachment jig 90 can be modified by, for example, making the leg parts 11 themselves thicker.

When the optical connector attachment/detachment jig 90 according to the example described above was mounted to the optical connector 300 coupled with a magnetic force of approximately 10 N, a magnetic force between the plug 200 and the receptacle 100 was reduced to 5 N or less, allowing the plug 200 to be readily attached to and detached from the receptacle 100, securing positional accuracy during mounting and preventing damage to the optical connector during attachment and detachment.

In the present example, as the optical connector 300, an optical connector of which the connection plate 220 had a lateral width of 8.0 mm, the magnet 230 had a lateral width of 8.6 mm, and the yoke 240 had a lateral width of 8.0 mm was used. Therefore, a margin between the connection plate 220 and the constricted portion of the leg part 11 of the front part 10, a margin between the magnet 230 and the leg part 11 of the front part 10, and a margin between the yoke 240 and the leg part of the rear part 20 were all approximately 0.1 mm.

In addition, in the case of the present example, by causing the plug engagement part 30 that is a constricted portion of the leg part 11 of the front part 10 to engage with the end part on the side of the receptacle 100 of the magnet 230 and causing the leg part 22 of the rear part 20 to engage with the end part on the side of the yoke 240 of the magnet 230, a movement of the plug 200 in the connection direction of the optical connector 300 can be reliably controlled by the optical connector attachment/detachment jig 90.

However, since attraction due to magnetic force acts between the receptacle 100 and the plug 200 when attaching and detaching the optical connector 300, the plug engagement part 30 and an end part on the side of the receptacle 100 of the magnet 230 are engaged with each other by the attraction and the engagement between the leg part 22 of the rear part 20 and the end part on the side of the yoke 240 of the magnet 230 is not necessarily required. Therefore, the lateral width of the yoke 240 may be set to 8.6 mm being the same lateral width as the magnet 230 and the width between the leg parts 22 of the rear part 20 may be set to 8.7 mm being the same width as between the leg parts 11 of the front part 10.

In addition, in the case of the present example, the lateral width of the receptacle 100 of the optical connector 300 is 8.0 mm and the distance between protrusions on both sides of the guide mechanism 12 is 8.1 mm, and alignment between the receptacle 100 and the plug 200 can be precisely performed by causing the guide mechanism 12 to engage with the receptacle 100.

Note that the shapes of the front part 10 and the rear part 20 in the present example are simply examples and the shapes may be appropriately modified according to the shape of the optical connector 300, whether the optical connector 300 is a single connector or a double connector, an engagement method between the optical connector 300 and the optical connector attachment/detachment jig 90, and the like.

In the present invention, the receptacle 100 corresponds to the “receptacle”, the magnet 230, the first magnet 231, and the second magnet 232 correspond to the “magnet”, the plug 200 corresponds to the “plug”, the optical connector 300 corresponds to the “optical connector”, the optical connector attachment/detachment jig 90 corresponds to the “optical connector attachment/detachment jig”, the front part 10 corresponds to the “front part”, the plug engagement part 30 corresponds to the “plug engagement part”, the optical fibers 140 and 270 correspond to the “optical waveguide component”, the connection plate 220 corresponds to the “connection plate”, the yoke 240 corresponds to the “yoke”, the rear part 20 corresponds to the “rear part”, and the guide mechanism 12 corresponds to the “guide mechanism”.

While a preferable embodiment of the present invention is as described above, the present invention is not limited thereto. It should be understood that various other embodiments may be made without deviating from the spirit and the scope of the present invention. Furthermore, while operations and effects due to the configuration of the present invention have been described in the present embodiment, the operations and effects are merely examples and are not intended to limit the present invention.

### REFERENCE SIGNS LIST

10 front part
12 guide mechanism
20 rear part
30 plug engagement part
90 optical connector attachment/detachment jig
100 receptacle
140, 270 optical fiber
200 plug
220 connection plate
230 magnet
231 first magnet
232 second magnet
240 yoke
300 optical connector

1. An optical connector attachment/detachment jig for attaching/detaching an optical connector in which a receptacle including a magnetic body and a plug including a magnet are coupled by magnetic force, the optical connector attachment/detachment jig comprising:
a front part that is formed from a magnetic body and covers a periphery of the magnet; and
a plug engagement part that engages with a distal-end part in a connection direction of the plug to remove the plug from the receptacle, wherein
the plug engagement part is a constricted portion that is formed on a side of the receptacle of the front part and has an inside diameter smaller than an outside diameter of an end part of the plug.

2. The optical connector attachment/detachment jig according to claim 1, wherein
the plug has a connection plate of a soft magnetic body on a side of the receptacle of the magnet,
the magnet includes a first magnet and a second magnet having an N pole and an S pole along a longitudinal direction of an optical waveguide component and being configured to face each other and to encompass the optical waveguide component, and
the front part is formed from a soft magnetic body and covers the first magnet and the second magnet to cause a magnetic circuit constituted of the first magnet and the second magnet to leak to a side of the front part to reduce the magnetic force between the receptacle and the plug.

3. The optical connector attachment/detachment jig according to claim 1, further comprising:
a rear part, wherein
the rear part is connected to the front part by a screw and engages with an upper surface and/or side surfaces of a yoke arranged on a rear-end part side of the magnet, and
the plug engagement part engages with a distal-end part of the magnet.

4. The optical connector attachment/detachment jig according to claim 12, wherein
each of the first magnet and the second magnet of the plug has a left-right symmetrical U-shape with an upper surface and a lower surface of each magnet configured to be flush with each other, and
the front part is in contact with the upper surface of each magnet.

5. The optical connector attachment/detachment jig according to claim 12, wherein
the front part includes a guide mechanism that protrudes toward a side of the receptacle and engages with the upper surface and/or the side surfaces of the receptacle.

6. An attachment/detachment method of an optical connector in which a receptacle including a magnetic body and a plug including a magnet are coupled by magnetic force, wherein
when attaching/detaching the optical connector, a periphery of the magnet is covered by an optical connector attachment/detachment jig formed from a magnetic body to cause a magnetic circuit constituted of the magnet to leak to the optical connector attachment/detachment jig and reduce a magnetic force between the receptacle and the plug.
